(19) United States
(12) Patent Application Publication
(10) Pub. No.: US 2012/0158365 A1
(43) Pub. Date: Jun. 21, 2012

(54) DEVICE AND METHOD FOR MONITORING EVENTS OVER A GEOGRAPHIC AREA

(75) Inventors: Martin LORD, St-Gerard des Laurentides (CA); Christian BACK, Trois-Rivieres (CA)

(73) Assignee: G.D.G. ENVIRONNEMENT LTEE, Trois-Rivieres (CA)

(21) Appl. No.: 12/968,553

(22) Filed: Dec. 15, 2010

(51) Int. Cl. G06F 15/00; G06F 17/40

(52) U.S. Cl. 702/187

(57) ABSTRACT

The present relates to a device and system for monitoring events over a geographic area performed by means of an apparatus, where the apparatus has an actuator for performing the events. The device comprises a trigger, a geographic location module and a processor. The trigger is adapted to be operationally engaged with the actuator of the apparatus. The trigger generates a confirmation signal upon actuation of the actuator of the apparatus by a user. The geographic location module obtains geographic location information. The processor periodically gathers geographic location information and associates to each confirmation signal a corresponding one of the geographic location information.

### FIELD

The present relates to monitoring of events over a geographic area, and more particularly to a device and system for performing such.

### BACKGROUND

Extermination of pest and/or pest control is necessary in both rural and urban areas. Problems with pest are rarely limited to a single area, but rather usually spread over a region. As the conditions for pest survival and reproduction vary over the region, concentration of pests may differ greatly from one area to another. The uneven concentration of pests over the region renders pest control and extermination difficult, and often results in application of too much chemicals in some areas. Some of the chemicals used for pest control and extermination can sometimes be harmful to human, or have associated therewith some serious potential side effects.

Another problem with pest control lies in the varying effectiveness of the chemicals used. Although application of a chemical may quickly exterminate and control pest population when the application is performed at a certain stage of the pest lifecycle, application of the same chemical in populations at different stages of lifecycles may prove inefficient and sometimes even useless.

There is thus a need for a device and system for monitoring events over a geographic area, and more particularly application of at least one compound.

### SUMMARY

In a first aspect, the present relates to a device for monitoring events over a geographic area performed by means of an apparatus. The apparatus has an actuator for performing the events. The present device comprises a trigger, a geographic location module and a processor. The trigger is adapted to be operationally engaged with the actuator of the apparatus. The trigger generates a confirmation signal upon actuation of the actuator of the apparatus by a user. The geographic location module obtains geographic location information. The processor periodically gathers geographic location information and associates to each confirmation signal corresponding geographic location information.

In another particular aspect, the device further comprises a memory for storing the associated confirmation signal and corresponding geographic location information.

In yet another aspect of the device, the memory further stores a list of codes, each code corresponding to a particular type of event. The device further comprises an entry module for the user to select one of the codes corresponding to one of the particular type of events. The processor further associates the code selected by the user by means of the entry module with each corresponding confirmation signal and geographic location information.

In again another aspect, the processor further generates a timestamp for the confirmation signal, and the memory further stores the timestamp with the associated confirmation signal and corresponding geographic location information.

In another particular aspect of the device, the timestamp comprises a debut time of the confirmation signal and an end time of the confirmation signal.

In another aspect, the events correspond to application of at least one compound, and the code selected by the user by means of the entry module corresponds to application of the at least one compound.

In yet another aspect, the entry module is further adapted for entering information of the user of the device.

In yet another particular aspect, the entry module is any of the following: a touch screen, a keypad, a trackball, or a plurality of buttons.

In another particular aspect, the device further comprises a display for displaying the identification of the compound.

In another aspect, the device also comprises a geographic positioning system for determining the geographic location information of the device.

In still another aspect, the device further comprises an output module for outputting the stored associated confirmation signal and corresponding geographic location information.

In yet another aspect, the present relates to a system for monitoring events over the geographic area performed by means of at least one of the present device. The system comprises an extraction module, and a map generation module. The extraction module extracts the stored confirmation signal and corresponding geographic location information from the memory of the device. The map generation module generates a geographic map of events based on the stored confirmation signal and corresponding geographic location information.

In another particular aspect of the system, the extraction module further extracts information about at least one compound and the map generation module further indicates on the generated geographic map information about the at least one compound.

In yet another aspect of the system, the extraction module further extracts identification of the user, and the system further comprises a time sheet generation module for generating a time sheet for the user, based on the extracted stored confirmation signal and identification of the user.

In still another aspect, the present system further comprises a report generation module for reporting monitored events.

### BRIEF DESCRIPTION OF THE DRAWING

In the following description, the following drawing is used to describe and exemplify the present device and system:

FIG. 1 is a schematic representation of an example of the present device and system.

### DETAILED DESCRIPTION

The present relates to a device and a system for monitoring events performed by means of an apparatus over a geographic area. The device is used to collect events information of the events performed by means of the apparatus. The events information may comprise one or several of the following: a confirmation signal, geographic location information, a timestamp, identity of the user of the device, and/or identification of a type of event performed by means of the apparatus. The system extracts the collected events information from one or several devices, and use the collected events information to generate various types of results, such as for example a map of performed events, time sheets, and various reports.

### DEFINITIONS

Throughout the present description and claims, the following words or expressions are used and are meant to be defined as follows:

Events: actions performed by a user by means of the apparatus;

Compound: any chemical or biological substance taken solely or in combination, the compound may be in solid, liquid, gaseous phase or a combination thereof; and

Module: an electronic component or combination of components, or a portion of a software program adapted to perform a specific task or group of tasks.

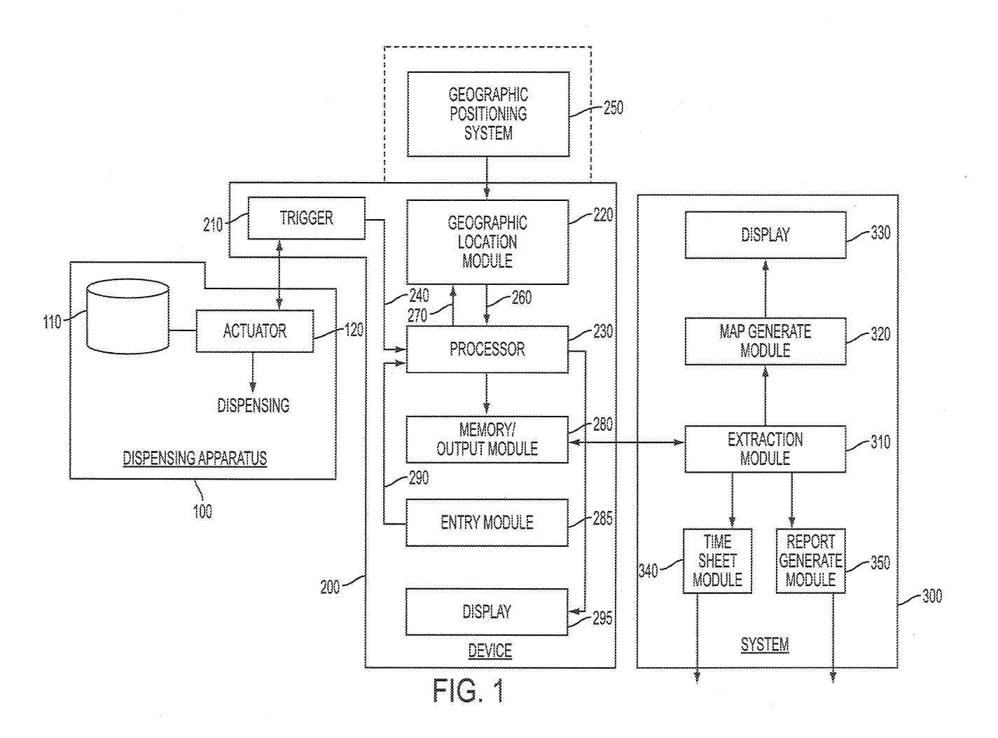

Reference is now made to FIG. 1, which depicts a schematic representation of an example of an exemplary apparatus 100, the present device 200 and present system 300. Although in the following description the exemplary apparatus described corresponds to a dispensing apparatus, the present device and system are not limited to use with only such an apparatus. As a matter of fact, the present device and system can be used with any type of apparatus being geographically mobile, and by means of which a user may perform one or several types of actions. For example, the present device and system could be used with the following types of apparatuses: pest control or extermination apparatuses, water dispenser, painting material, marking over geographic areas, measurements over a geographic area, agriculture, etc. For simplicity purposes only, the following description will pursue with a dispensing apparatus, but the scope of the present device and system should not be interpreted as being limited to such an apparatus.

### Dispensing Apparatus

The dispensing apparatus 100 may consist of any type of dispensing apparatus known and used in the field of chemical and biological application over geographic areas. The dispensing apparatus may be a portable dispensing apparatus adapted to be worn by a user, or a dispensing apparatus mounted on a vehicle such as a truck. The dispensing apparatus 100 may comprise one or several containers 110, each container carrying a different compound, or several containers carrying the same compound. The dispensing apparatus comprises an actuator 120. The actuator 120 actuates dispensing of the compound in the container 110. The actuator 120 may consist of any type of actuator known in the art, such as for example a mechanical actuator, an electric actuator, an electronic actuator, etc.

In a particular aspect, the dispensing apparatus is adapted for dispensing a compound for exterminating or controlling pest. Examples of compounds that may be dispensed by the dispensing apparatus comprises the following examples: pesticides both chemical and biological in any phase such as solid, liquid or gaseous.

### Device

The present device 200 monitors events performed by means of the apparatus 100 over a geographic area. The geographic area may correspond to a predefined area or perimeter, or more generally to a region. The events may correspond to different types of actions, depending on the type of apparatus with which the present device is used. For example, in the case of a dispensing apparatus, events may correspond to application of a particular compound. As previously indicated, the present device and system are not limited to the dispensing apparatus shown on FIG. 1. In the case of a measurement apparatus, the events may correspond to any type of measurements being performed in various locations of a geographic area, for example bacteria density, pest population, humidity level, water depth, soil values, air quality, water quality, environmental measurements, tree population, etc. In another aspect, the events may correspond to gathering of material, such as for example gathering of samples, where each type of event correspond to a particular type of sample.

The device 200 comprises a trigger 210, a geographic location module 220 and a processor 230. The trigger is adapted to be operationally engaged with the actuator 120 of the apparatus 100. Thus, depending on which type of actuator 120 is used, various types of triggers 210 may be selected. Examples of triggers 210 that can be used include: an electric trigger, an electronic trigger, a mechanical trigger, a mechanically operated trigger. As the trigger 210 is operationally engaged with the actuator 120, when the actuator 120 is actuated by the user, the trigger 210 generates a confirmation signal 240. The trigger 210 may be operationally engaged by, for example, any of the following means: physical superposition over the actuator 120, electrical connection with the actuator 120, electronic connection with the actuator either direct or not, software trigger detection, etc. The confirmation signal 240 may for example be a tension variation, an electric current, or a specific message generated by the trigger 210.

The device further comprises a geographic location module 220. The geographic location module is adapted for obtaining geographic location information. For doing so, the geographic location module 220 may optionally include an integrated geographic positioning system, or communicate with an external geographic positioning system 250. The geographic location information 260 is formatted if necessary by the geographic location module 220, so as to be in a format recognized by the processor 230. The geographic location information 260 is obtained on a periodical basis such as for example every second, or at any interval suitable for the events to be monitored by the device.

The processor 230 receives the geographic location information 260 obtained periodically, and the confirmation signal 240 upon actuation of the actuator of the apparatus by a user, and associates for each confirmation signal 240 the corresponding geographic location information 260. The processor is further adapted for generating a geographic location information request 270 sent to the geographic location module 220 upon receipt of the confirmation signal 240.

The processor 230 also generates a timestamp for at least each confirmation signal 240. Alternately, the processor can generate a timestamp for each geographic information location obtained. The timestamp may comprise one or several of the following: a date and time of the receipt of the confirmation signal 240, or a debut date and time of the confirmation signal 240 and an end date and time of the confirmation signal 240.

The processor 230 is further adapted for formatting the confirmation signal 240 and the geographic location information 240 if required, before storing the latter in a memory 280. The processor 230 further stores the timestamp information for the confirmation signal 240 in the memory 280 and/or the geographic location information. The processor 230 may consist of any type of processor, such as for example an Erasable Programmable Read Only Memory, a microprocessor, a central processing unit.

The memory 280 stores the timestamp with the associated confirmation signal and corresponding geographic location information. Alternately, the memory may store the timestamp with the corresponding geographic location information, and an indication of the corresponding of the geographic location information with the confirmation signal. The memory may consist of any type of memory, such as for example: flash memory, or any type of memory card.

The device 200 further comprises an entry module 285 for entering by the user of the apparatus 100 an identification of a type of event to be performed by means of the apparatus 100. In the event that the apparatus is a dispensing apparatus adapted for dispensing various compounds, it is useful for monitoring the events over the geographic area to track when, where and which compound is being dispensed. For doing so, the user uses the entry module 285 for identifying which compound will be dispensed by means of the identification of the corresponding type of event. Typically, the user of the apparatus will identify the compound that will be dispensed by means of the entry module 285 before actuating the actuator 120, and thus the trigger 210 operationally engaged therewith. As previously discussed, various types of events could be monitored. For doing so, a group of type of events and corresponding identification may be created, and stored in the memory 280. Then, before performing an event, the user of the apparatus enters by means of the entry module 285 the type of event about to be performed. The entered type of event 290 is communicated by the entry module 285 to the processor 230. The entry module 285 may further be adapted for entering other information by the user, such as for example information such as identification of the user, information of a contract, client information, particularities of the compound being dispersed such as for example phase, field conditions such as temperature, humidity, weather, etc. For doing so, the entry module may be implemented in various forms: a touch screen, a keypad, a trackball, a plurality of buttons, or a numerical keypad. The entry module communicates the entered information 290 to the processor 230, which is further adapted for storing the entered information, i.e. the type of event, in the memory 280 in such a way as to be retrievable and accessible. Additionally, the type of event could be stored and associated with confirmation signals received thereafter, until another type of event is entered by means of the entry module 285.

In a particular aspect of the present device, the types of events correspond to a list, for which each type of event is identified by a four-digit numerical code. The list of four-digit numerical codes and corresponding type of events are stored in the memory. Upon entry by the user of one of the 4-digit numerical code by means of the entry module 285, the entered 4-digit numerical code is displayed on a display 295. The 4-digit numerical code is then associated with each confirmation signal 240 received afterwards, until a new type of event 290 is entered by the user. The 4-digit numerical code can be customized to correspond to tasks to be performed by the apparatus 100.

The device 200 may further comprise a display 295. The display 295 may be used for displaying various information, such as for example the entered type of event, the identification of the compound to be dispensed or being dispensed, information about the user of the dispensing apparatus 100, contract information, client information, geographic location information, etc. The display 295 may consist of a screen cooperating with a graphic card and graphical interface controlled by the processor 230. Alternately, the display 295 and the entry module 285 may be combined into a touch screen wherein the display portion is controlled by the processor 230.

The device 200 further comprises an output module. The output module may be embedded with the memory 280 (as shown on FIG. 1) or be a separate module (not shown). The output module is adapted for outputting the stored information, i.e. associated confirmation signal, corresponding geographic location information, timestamp information and type of event, user information, etc., to a system 300 for monitoring. The output module may further communicate with the system 300 following a predefined and/or standardized protocol or mechanism. The output module may communicate with the system 300 either in a wired or wireless manner. For wired communication, the output module further comprises a connector (not shown). The connector may be any type of electric connector known in the art, such as an 8P8C connector, a D-subminiature connector, a USB connector, an RJ-connector, . . . . For wireless communications, the output module comprises a wireless modem or a radio frequency transmitter such as a Bluetooth transmitter or a standardized mobile phone transmitter.

The components of the device 200, namely the geographic location module 220, the processor 230, the memory 280, the output module, the entry module 285 and the display 295 are preferably encased within a rugged casing, for protecting the components from the elements. The trigger 210 is also preferably ruggedized for protection purposes.

The components of the device 200 may be composed of hardware, software or a combination thereof. The various components may be organized in various ways, and combined or arranged independently.

In a particular aspect of the present device, the processor receives two different types of information: periodic geographic location information, and sporadic confirmation signals and type of events. The processor 230 may thus associate a timestamp with the period geographic location information, which serves as a timeline information. Then, the events are associated to the timeline information as the confirmation signals are received, and the type of event is entered by the user of the apparatus. By combining both periodic information with sporadic information, it renders more simple the associating and storing of information by the processor, and the extraction, filtering, processing and reporting of the monitored events.

### System

The system 300 is for monitoring events performed by means of the device 200. The device 200 is adapted for collecting information relative to the events over a geographic area. The system extracts or receives the collected information from one or several devices 200, and generates there from various types of maps or reports.

For doing so, the system 300 comprises an extraction module 310. The extraction module 310 is adapted for communicating with the output module of the device 200 and downloading the stored information. The extraction module 310 may communicate with the output module either in a wired or wireless fashion. The extraction module 310 is further adapted for downloading stored information from several devices 200 concurrently. More particularly, the extraction module 310 extracts the stored geographic location information, timestamp information, confirmation signals, type of event information, and the user information. The extraction module 310 may further extract all other information stored in the memory 280 of the device 200, such as field related information, identification of the compound, etc. The extraction module 310 further stores the extracted information.

The system 300 further comprises a map generation module 320. The map generation module 320 generates a geographic map for a portion of the extracted information or for all the information extracted for one device 200. The map generation module 320 filters the extracted information based on various possible factors taken solely or in combination, such as: identification of the user, geographic location information corresponding to a region of interest, type of events performed in a certain date and/or time range, type of events related to a particular compound or a combination thereof, field information, etc. The map generation module thus filters the extracted information, so as to compile only the records corresponding to the filtering criteria, and generating there from a map representative of the compiled information.

For example, the map generation module 320 may filter the extracted information from a plurality of devices 200, so as to identify the extracted information corresponding to events related to application of a group of compounds over a geographic area during a predefined period by a group of technicians (users). Then, the filtered extracted information is compiled and graphically represented on a map corresponding to the geographic area of interest. For filtered extracted information, corresponding information such as compound dispensed, duration of the dispensing of the compound, user who performed the dispensing, etc may be displayed.

The map generation module 320 may thus be customized by a user of the system, so as to display a map corresponding to the information of interest. The information of interest may vary greatly for types of events being monitored. For example, for some events, duration of the event will be particularly interesting, while for other events, date and time of the event will be of greater interest.

In addition to filtering the extracted information, additional processing may be performed on the extracted information. For example, in the case of events corresponding to application of compounds, by extracting the type of apparatus and the timestamp information, it is possible to deduce the quantity of compound applied.

The map generation module 320 is further capable of superposing the compiled filtered extracted information, and the additionally processed information, with for example field evaluations of the density of pests to be exterminated or controlled. Such information may be particularly interesting to ensure that the events corresponding to application of pest control related compounds are well targeted, and to monitor efficiency of the applications.

The system 300 further comprises a time sheet generation module 340. The time sheet generation module 340 filters the extracted information so as to generate a time sheet for each user, based on the extracted stored confirmation signal and identification of the user.

The system 300 further comprises a report generation module 350. The report generation module 350 is adapted for generating various types of reports, such as for example distributed quantities of one compound over a particular geographical area, over a predetermined of time. The extracted information may be filtered in various ways, so as to generate any type of report such as for example over geographic area, time, compound, user, and weather conditions, taken alone or in combination.

The map generation module 320, the time sheet module 340 and the report generation module 350 may output the generated maps or reports either on paper form, electronically to be received by another recipient, or on a display 330.

The system 300 may be implemented as a standalone machine, or realized in software installed on a computer or electronic device. The various components of the system 300, namely the extraction module 310, the map generation module 320, the time sheet generation module 340 and the report generation module 350 may be implemented in hardware, in software, in a combination thereof, and may be rearranged differently, without departing from the present scope. The software components could be downloaded from a server, installed by means of a computer readable medium such as a Compact-Disc memory or flash memory.

Although the present device and system have been described by way of various embodiments in the present description, the present device and system are not limited to such arrangements. The present device and system may be modified and rearranged in various ways without departing from the scope of protection of the present claims.

1. A device for monitoring events over a geographic area performed by means of an apparatus, the apparatus having an actuator for performing the events, the device comprising:
a trigger adapted to be operationally engaged with the actuator of the apparatus, the trigger generating a confirmation signal upon actuation of the actuator of the apparatus by a user;
a geographic location module for obtaining geographic location information; and
a processor for periodically obtaining geographic location information and for associating for each confirmation signal a corresponding geographic location information.

2. The device of claim 1, further comprising a memory for storing the associated confirmation signal and corresponding geographic location information.

3. The device of claim 2, wherein:
the memory further stores a list of types of events;
the device further comprising an entry module for the user to select one of the types of events; and
the processor further associates the type of event selected by the user with each corresponding confirmation signal and geographic location information.

4. The device of claim 1, wherein the processor further generates a timestamp for the confirmation signal, and the memory further stores the timestamp with the associated confirmation signal and corresponding geographic location information.

5. The device of claim 4, wherein the timestamp comprises a debut time of the confirmation signal and an end time of the confirmation signal.

6. The device of claim 3, wherein:
the types of events correspond to application of at least one compound;
the type of event selected by the user corresponds to application of a particular compound.

7. The device of claim 6, wherein the entry module is further adapted for entering information of the user of the device.

8. The device of claim 6, wherein the entry module is any of the following: a touch screen, a keypad, a trackball, or a plurality of buttons.

9. The device of claim 6, further comprising a display for displaying the identification of the compound.

10. The device of claim 1, further comprising a geographic positioning system for determining the geographic location information of the device.

11. The device of claim 2, further comprising an output module for outputting the stored associated confirmation signal and corresponding geographic location information.

12. A system for monitoring events over the geographic area performed by means of at least one device of claim 1, the system comprising:
an extraction module for extracting the stored confirmation signal and corresponding geographic location information from the memory of the device; and
a map generation module for generating a geographic map of events based on the stored confirmation signal and corresponding geographic location information.

13. The system of claim 12, wherein the extraction module further extracts information about at least one compound, and the map generation module further indicates on the generated geographic map information about the at least one compound.

14. The system of claim 12, wherein the extraction module further extracts identification of the user, and the system further comprises a time sheet generation module for generating a time sheet for the user, based on the extracted stored confirmation signal and identification of the user.

15. The system of claim 12, further comprising a report generation module for generating reporting monitored events.
